(19) United States
(12) Patent Application Publication
(10) Pub. No.: US 2026/0208564 A1
(43) Pub. Date: Jul. 23, 2026

(54) SMELL CONTROL DEVICE, SMELL CONTROL METHOD, AND VEHICLE

(71) Applicant: TOYOTA JIDOSHA KABUSHIKI KAISHA, Toyota-shi (JP)

(72) Inventors: Naoki UENOYAMA, Kasugai-shi (JP); Koki MORI, Inuyama-shi (JP); Yuki NAKAGAWA, Toyota-shi (JP); Teruyuki KANOU, Nagoya-shi (JP)

(73) Assignee: TOYOTA JIDOSHA KABUSHIKI KAISHA, Toyota-shi (JP)

(21) Appl. No.: 19/416,491

(22) Filed: Dec. 11, 2025

(30) Foreign Application Priority Data
Jan. 21, 2025 (JP) 2025-008534

(51) Int. Cl. B60H 3/00; G06V 20/59; G10L 17/06

(52) U.S. Cl. CPC B60H 3/0035; G06V 20/593; G10L 17/06

(57) ABSTRACT

A smell control device includes a processor. The processor is configured to: acquire, from a server, operation schedule information indicating a schedule of operation of a vehicle; based on the operation schedule information, recognize an occupant who is to gets on the vehicle, and determine whether the occupant is a target person of smell control; and in response to determining that the occupant is the target person, activate a smell control function before the occupant gets on the vehicle, after the occupant gets on the vehicle, or after the occupant gets off the vehicle.

### CROSS-REFERENCE TO RELATED APPLICATION

This application claims priority to Japanese Patent Application No. 2025-008534

filed on Jan. 21, 2025. The disclosure of the above-identified application, including the specification, drawings, and claims, is incorporated by reference herein in its entirety.

### BACKGROUND

### 1. Technical Field

The present disclosure relates to a smell control device, a smell control method, and a vehicle.

### 2. Description of Related Art

There have been known a technology for identifying a person aboard a vehicle, and a technology for changing smell inside a vehicle. For example, Japanese Unexamined Patent Application Publication No. 2010-216869 (JP 2010-216869 A) discloses a technology by which when a ride is detected based on a signal from a sensor, current position information is acquired as riding position information, and individual identification information corresponding to the acquired riding position information is retrieved by referring to a database in which individual identification information and position information are associated with each other. Moreover, Japanese Unexamined Patent Application Publication No. 8-47524 (JP 8-47524 A) discloses a technology by which an oily fragrance liquid which emits the scent of a new conveyance is mixed with an organic blowing agent, a pyrogenic agent is made to generate heat around the fragrance liquid inside a conveyance so as to make the blowing agent blow to atomize the fragrance liquid and make the atomized fragrance liquid adhere to the interior of the conveyance.

### SUMMARY

There are some occasions when an occupant of a vehicle is bothered by a smell inside the vehicle. However, with the conventional technologies, it has been difficult to control smell inside a vehicle at an appropriate timing.

The present disclosure provides a smell control device, a smell control method, and a vehicle that can control smell inside a vehicle at an appropriate timing.

A smell control device according to a first embodiment of the present disclosure includes a processor. The processor is configured to: acquire, from a server, operation schedule information indicating a schedule of operation of a vehicle; based on the operation schedule information, recognize an occupant who is to get on the vehicle, and determine whether the occupant is a target person of smell control; and in response to determining that the occupant is the target person, activate a smell control function before the occupant gets on the vehicle, after the occupant gets on the vehicle, or after the occupant gets off the vehicle.

A smell control device according to a second embodiment of the present disclosure includes a processor configured to recognize an occupant who is to get on a vehicle, and, in a case that the occupant is a target person of smell control, activate a smell control function before the occupant gets on the vehicle, after the occupant gets on the vehicle, or after the occupant gets off the vehicle. in the smell control device according to the second embodiment of the present disclosure, the processor may be configured to, in a case that the occupant is the target person, present, to a driver, a proposal that smell control be started before the occupant gets on the vehicle, after the occupant gets on the vehicle, or after the occupant gets off the vehicle, and activate the smell control function, based on an instruction from the driver. in the smell control device according to the second embodiment of the present disclosure, the processor may be configured to: acquire information indicating a scheduled date and time at which the occupant gets on the vehicle; and activate the smell control function in response to the current date and time reaching a predetermined period of time prior to the scheduled date and time. in the smell control device according to the second embodiment of the present disclosure, the processor may be configured to receive, from a microphone provided in the vehicle, an input of voice information picked up by the microphone, analyze the voice information, and determine whether the occupant gets on or gets off the vehicle based on an analysis result.

In the smell control device according to the second embodiment of the present disclosure, the processor may be configured to receive, from a camera provided in the vehicle, an input of image information picked up by the camera, analyze the image information, and determine whether he occupant gets on or gets off the vehicle based on an analysis result.

In the smell control device according to the second embodiment of the present disclosure, the processor may be configured to receive, from one or more sensors provided in the vehicle, sensor information detected by the one or more sensors, analyze the sensor information, and determine whether the occupant gets on or gets off the vehicle based on an analysis result.

In the smell control device according to the second embodiment of the present disclosure, the one or more sensors may include a seatbelt sensor.

In the smell control device according to the second embodiment of the present disclosure, the smell control function may be an odor elimination function, an odor removal function, or an air freshening function.

A smell control method according to a third embodiment of the present disclosure includes: by a smell control device, acquiring, from a server, operation schedule information indicating a schedule of operation of a vehicle; based on the operation schedule information, recognizing an occupant who is to get on the vehicle, and determining whether the occupant is a target person of smell control; and in response to determining that the occupant is the target person, activating a smell control function before the occupant gets on the vehicle, after the occupant gets on the vehicle, or after the occupant gets off the vehicle.

A smell control method according to a fourth embodiment of the present disclosure includes, by a smell control device, recognizing an occupant who is to get on a vehicle, and, in a case that the occupant is a target person of smell control, activating a smell control function before the occupant gets on the vehicle, after the occupant gets on the vehicle, or after the occupant gets off the vehicle.

The smell control method according to the fourth embodiment of the present disclosure may further include, by the smell control device, in a case the occupant is the target person, presenting, to a driver, a proposal that smell control be started before the occupant gets on the vehicle, after the occupant gets on the vehicle, or after the occupant gets off the vehicle, and activating the smell control function, based on an instruction from the driver.

The smell control method according to the fourth embodiment of the present disclosure may further include: by the smell control device, acquiring information indicating a scheduled date and time at which the occupant gets on the vehicle; and activating the smell control function in response to the current date and time reaching a predetermined period of time prior to the scheduled date and time.

The smell control method according to the fourth embodiment of the present disclosure may further include: by the smell control device, receiving, from a microphone provided in the vehicle, an input of voice information picked up by the microphone; analyzing the voice information; and determining whether the occupant gets on or gets off based on an analysis result.

The smell control method according to the fourth embodiment of the present disclosure may further include: by the smell control device, receiving, from a camera provided in the vehicle, an input of image information picked up by the camera; analyzing the image information; and determining whether the occupant gets on or gets off based on an analysis result.

The smell control method according to the fourth embodiment of the present disclosure may further include: by the smell control device, receiving, from one or more sensors provided in the vehicle, sensor information detected by the one or more sensors; analyzing the sensor information; and determining whether the occupant gets on or gets off based on an analysis result.

In the smell control method according to the fourth embodiment of the present disclosure, the one or more sensors may include a seatbelt sensor.

In the smell control method according to the fourth embodiment of the present disclosure, the smell control function may be an odor elimination function, an odor removal function, or an air freshening function.

A vehicle according to a fifth embodiment of the present disclosure may include: the smell control device according to the first embodiment or the second embodiment; and a deodorization device. In response to determining that the occupant is the target person of smell control, the deodorization device may be configured to eliminate or remove an odor, based on an instruction from the smell control device.

A vehicle according to a sixth embodiment of the present disclosure may include: the smell control device according to the first embodiment or the second embodiment; and an air freshening device. In response to determining that the occupant is the target person of smell control, the air freshening device is configured to release a fragrance, based on an instruction from the smell control device.

According to the present disclosure, it is possible to control smell inside a vehicle at an appropriate timing.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1 shows a schematic configuration of a smell control system according to an embodiment;

FIG. 2 is a flowchart showing a procedure of a first smell control method that is executed by a smell control device according to the embodiment;

FIG. 3 is a flowchart showing a procedure of a second smell control method that is executed by the smell control device according to the embodiment; and

FIG. 4 is a flowchart showing a procedure of a third smell control method that is executed by the smell control device according to the embodiment.

### DETAILED DESCRIPTION OF EMBODIMENTS hereafter, an embodiment of the present disclosure is described in detail with reference to the drawings.

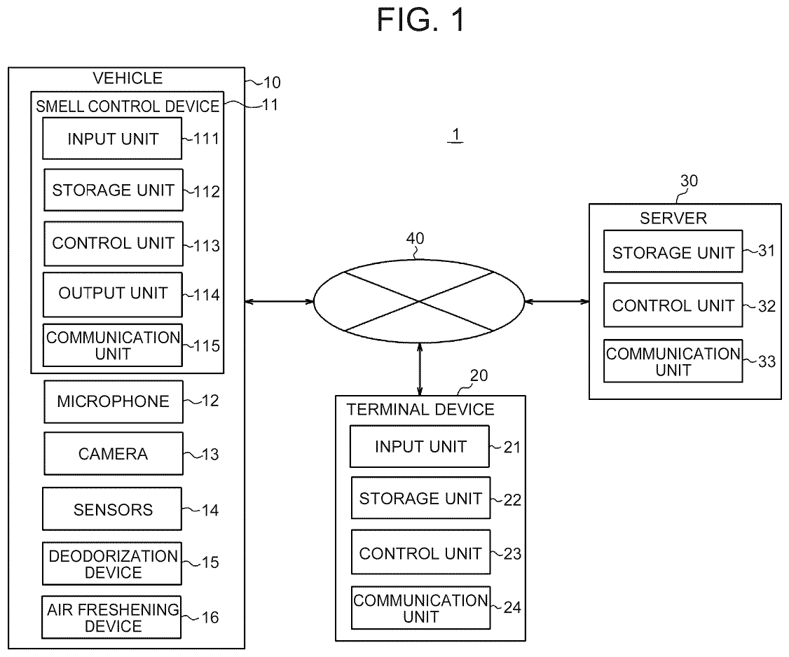

A configuration of a smell control system according to the embodiment is described with reference to FIG. 1. The smell control system 1 shown in FIG. 1 includes a vehicle 10, a terminal device 20, and a server 30. The vehicle 10 and the server 30 are communicably connected to each other through a network 40. The terminal device 20 and the server 30 are communicably connected to each other through the network 40.

The terminal device 20 is, for example, a smartphone, a tablet terminal, a personal computer (PC), or the like. The terminal device 20 includes an input unit 21, a storage unit 22, a control unit 23, and a communication unit 24.

The input unit 21 includes an interface, such as a physical key, a capacitive key, or a touch screen, that receives an input from an operator of the terminal device 20. The input unit 21 receives an input of information (hereinafter, referred to as “operation schedule information”) indicating a schedule of operation of the vehicle 10 from the operator of the terminal device 20. The operation schedule information includes information indicating a scheduled date and time (hereinafter, referred to as “scheduled date and time of passenger ride start”) at which a person other than the owner of the vehicle 10 will ride the vehicle 10. The operation schedule information may include information for identifying the passenger, such as a name of the passenger, attribute information, or a relation (husband, wife, older brother, younger brother, older sister, younger sister, friend, senior, junior, boss, subordinate, customer) with the owner of the vehicle 10. The attribute information includes gender, age, and the like. The operation schedule information may include information indicating whether the passenger is a target person of smell control. For example, a target person of smell control may be a person other than the owner. In such a case, information indicating a target person of smell control is associated with the person other than the owner. A target person of smell control does not need to be a person other than the owner. For example, a target person of smell control may be settable beforehand by an operator of the terminal device 20. For example, it may be predetermined that a target person of smell control is a person other than a family member. For example, a target person of smell control may be a person who has never been a target person of smell control. The input unit 21 outputs the input information to the storage unit 22.

The storage unit 22 includes at least one semiconductor memory, at least one magnetic memory, at least one optical memory, or a combination of any thereof. The semiconductor memory is, for example, a random access memory (RAM), a read only memory (ROM), a flash memory, or the like. The storage unit 22 functions as, for example, a main storage device, an auxiliary storage device, or a cache memory. The storage unit 22 stores information that is used for operation of the terminal device 20.

The control unit 23 includes at least one processor, at least one programmable circuit, at least one dedicated circuit, or a combination of any thereof. The processor is a general-purpose processor, such as a central processing unit (CPU) or a graphics processing unit (GPU), or a dedicated processor specific to a particular process. The programmable circuit is, for example, a field-programmable gate array (FPGA). The dedicated circuit is, for example, an application specific integrated circuit (ASIC). The control unit 23 executes processing related to operation of the terminal device 20 while controlling each unit of the terminal device 20. For example, the control unit 23 transmits operation schedule information acquired via the input unit 21 and the storage unit 22 to the server 30 by controlling the communication unit 24.

The communication unit 24 includes a communication interface for communicating with the server 30. The communication interface may be, for example, an interface that supports a mobile communication standard, such as Long Term Evolution (LTE), 4th generation (4G), or 5th generation (5G). The communication unit 24 outputs received information to the storage unit 22.

The server 30 is a server that manages a schedule of operation of the vehicle 10. The server 30 includes a storage unit 31, a control unit 32, and a communication unit 33.

The storage unit 31 includes at least one semiconductor memory, at least one magnetic memory, at least one optical memory, or a combination of any thereof. The semiconductor memory is, for example, a RAM, a ROM, a flash memory, or the like. The storage unit 31 functions as, for example, a main storage device, an auxiliary storage device, or a cache memory. The storage unit 31 stores information that is used for operation of the server 30.

The control unit 32 includes at least one processor, at least one programmable circuit, at least one dedicated circuit, or a combination of any thereof. The processor is a general-purpose processor, such as a CPU or a GPU, or a dedicated processor specific to a particular process. The programmable circuit is, for example, an FPGA. The dedicated circuit is, for example, an ASIC. The control unit 32 executes processing related to operation of the server 30 while controlling each unit of the server 30. For example, the control unit 32 transmits operation schedule information acquired via the communication unit 33 and the storage unit 31 from the terminal device 20 to a smell control device 11 by controlling the communication unit 33. The control unit 32 may extract and transmit to the smell control device 11 only information, of the operation schedule information, that is necessary for the smell control device 11. The information that is necessary for the smell control device 11 is, for example, a scheduled date and time of passenger ride start and information indicating whether a passenger is a target person of smell control.

The communication unit 33 includes a communication interface for communicating with the smell control device 11 and the terminal device 20. The communication interface may be, for example, an interface that supports a mobile communication standard, such as LTE, 4G, or 5G. The communication unit 33 outputs received information to the storage unit 31.

The vehicle 10 includes the smell control device 11, a microphone 12, a camera 13, sensors 14, a deodorization device 15, and an air freshening device 16. The vehicle 10 may include only any one of the microphone 12 and the camera 13. The vehicle 10 may include only any one of the deodorization device 15 and the air freshening device 16.

The microphone 12 is installed in the vehicle 10 and picks up voice of a speaker. The microphone 12 includes a sound pickup element. The sound pickup element is, for example, a micro-electromechanical system (MEMS) microphone, an electret-condenser microphone (ECM), or the like. The type of the sound pickup element is not limited.

The camera 13 is installed in the vehicle 10 and picks up (captures) an image of at least the inside of the vehicle 10. The camera 13 is, for example, a charge-coupled device (CCD) camera, a complementary metal-oxide-semiconductor (CMOS) camera, a high-speed camera, or the like.

The sensors 14 are one or more sensors installed in the vehicle 10. The sensors 14 may include a seatbelt sensor that detects fastening and unfastening of a seatbelt. The seatbelt sensor is attached to, for example, a buckle of the seatbelt and detects that a tongue (tongue plate) of the seatbelt is inserted into the buckle. The sensors 14 may include a door sensor that detects opening and closing of a door. The sensors 14 may include a key sensor that detects locking and unlocking of a door.

The deodorization device 15 activates a deodorization function (odor elimination function or odor removal function), based on an instruction from the smell control device 11, and eliminates or removes an odor inside the vehicle 10. For example, the deodorization device 15 eliminates an odor by decomposing molecules of the odor by causing chemical reaction with hypochlorous acid or the like. For example, the deodorization device 15 removes an odor by allowing molecules of the odor to be adsorbed by an adsorbent, such as activated charcoal. The deodorization device 15 may include a sterilization function that sterilizes bacteria inside the vehicle 10. The deodorization device 15 may include a virus removal function that removes virus inside the vehicle 10.

The air freshening device 16 activates an air freshening function, based on an instruction from the smell control device 11, and releases a fragrance toward the inside of the vehicle 10. For example, the air freshening device 16 diffuses, by spraying or vaporizing, a fragrance compound in the air.

The smell control device 11 determines a timing at which deodorization or air freshening is required, and controls smell inside the vehicle 10. The smell control device 11 includes an input unit 111, a storage unit 112, a control unit 113, an output unit 114, and a communication unit 115.

When the vehicle 10 includes the microphone 12, the input unit 111 includes an interface via which voice information is input from the microphone 12. When the vehicle 10 includes the camera 13, the input unit 111 includes an interface via which image information is input from the camera 13. Moreover, the input unit 111 includes an interface, such as a physical key, a capacitive key, or a touch screen, that receives an input from an operator of the smell control device 11. The input unit 111 outputs the input information to the storage unit 112.

The storage unit 112 includes at least one semiconductor memory, at least one magnetic memory, at least one optical memory, or a combination of any thereof. The semiconductor memory is, for example, a RAM, a ROM, a flash memory, or the like. The storage unit 112 functions as, for example, a main storage device, an auxiliary storage device, or a cache memory. The storage unit 112 stores information that is used for operation of the smell control device 11.

The control unit 113 includes at least one processor, at least one programmable circuit, at least one dedicated circuit, or a combination of any thereof. The processor is a general-purpose processor, such as a CPU or a GPU, or a dedicated processor specific to a particular process. The programmable circuit is, for example, an FPGA. The dedicated circuit is, for example, an ASIC.

The control unit 113 executes processing related to operation of the smell control device 11 while controlling each unit of the smell control device 11. The control unit 113 acquires operation schedule information from the server 30, and from the operation schedule information, recognizes an occupant who will ride the vehicle 10 and determines whether the occupant is a target person of smell control. When the occupant is a target person of smell control, the control unit 113 activates a smell control function and controls smell inside the vehicle 10 before the occupant rides the vehicle 10, after the occupant rides the vehicle 10, or after the occupant alights from the vehicle 10. Details of the processing by the control unit 113 will be described later.

The output unit 114 includes an interface, such as a display or a speaker, that outputs information created by the control unit 113. Note that the input unit 111 and the output unit 114 may be configured as a single unit like a touch screen.

The communication unit 115 includes a communication interface for communicating with the sensors 14. The communication unit 115 includes a communication interface for communicating with the server 30. In a case of wired communication, the communication interface may be an interface that supports a communication standard, such as local area network (LAN) interface or universal serial bus (USB). In a case of wireless communication, the communication interface may be an interface that supports a mobile communication standard, such as LTE, 4G, or 5G, or an interface that supports short-range wireless communication, such as Bluetooth. The communication unit 115 outputs received information to the storage unit 112.

### Smell Control Methods

Next, smell control methods that are executed by the smell control device 11 are described. The smell control methods to be described below are premised on the assumption that the terminal device 20 has transmitted operation schedule information to the server 30.

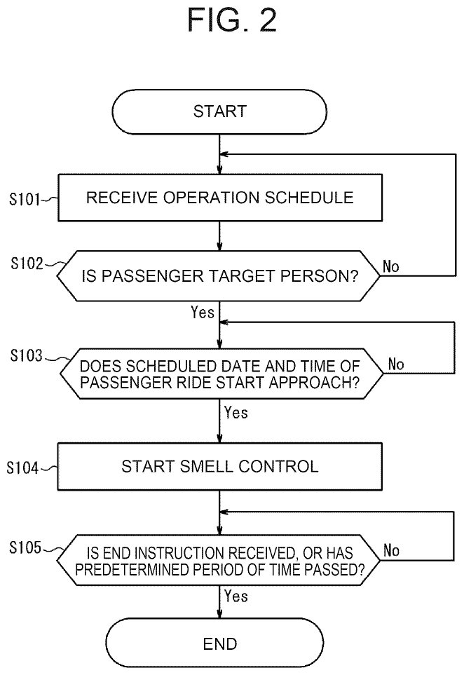

FIG. 2 is a flowchart showing a procedure of a first smell control method that is executed by the smell control device 11. in S101, the communication unit 115 receives the operation schedule information from the server 30. A timing at which the server 30 transmits the operation schedule information may be decided by an operator of the terminal device 20 and then indicated to the server 30, or may be automatically decided by the server 30. The server 30 may transmit the operation schedule information a predetermined period of time (for example, one hour) before a scheduled date and time of passenger ride start. in S102, the control unit 113, from the operation schedule information,

recognizes an occupant (passenger) who will ride the vehicle 10 later, and determines whether the passenger is a target person of smell control. The control unit 113 advances the processing to S103 when it is determined that the passenger is a target person of smell control, and returns the processing to S101 when it is determined that the passenger is not a target person of smell control.

When the operation schedule information does not include information indicating whether the passenger is a target person of smell control, the control unit 113 may decide that a person other than the owner of the vehicle 10 is a target person of smell control. The control unit 113 may decide on a target person of smell control, based on a relation with the owner of the vehicle 10. For example, the control unit 113 may decide that a person other than a family member of the owner of the vehicle 10 is a target person of smell control, or may decide that a senior, a boss, a customer, or the like of the owner of the vehicle 10 is a target person of smell control. The control unit 113 may decide that a person who has never been a target person of smell control is a target person of smell control. In S103, the control unit 113, from the operation schedule information,

recognizes the scheduled date and time of passenger ride start and, when the current date and time is a predetermined period of time (for example, zero to five minutes) before the scheduled date and time of passenger ride start, advances the processing to S104. In other words, the control unit 113 advances the processing to S104 when the scheduled date and time of passenger ride start approaches. In S104, the control unit 113 activates the deodorization device 15 or the air freshening device 16 (activates the smell control function) and starts smell control. When the deodorization device 15 is activated, the deodorization device 15 eliminates or removes an odor inside the vehicle 10. When the air freshening device 16 is activated, the air freshening device 16 releases a fragrance toward the inside of the vehicle 10. The control unit 113 may recognize attribute information on the passenger from the operation schedule information, and may instruct the air freshening device 16 to release a fragrance that is varied based on the attribute information on the passenger. For example, the control unit 113 may recognize a gender or an age, and may instruct the air freshening device 16 to release a fragrance that is varied according to the gender or the age of the passenger. The control unit 113 may instruct the air freshening device 16 to release a fragrance that is varied according to the season, the month, or the hours. The control unit 113 may identify the passenger and may instruct the air freshening device 16 to release a fragrance that is varied according to the passenger.

In S104, the control unit 113 may present, to a driver, a proposal that smell control be started by the deodorization device 15 or the air freshening device 16, and may activate the smell control function, based on an instruction from the driver. For example, the control unit 113 may cause the output unit 114 to display a massage “It is ○ minutes before the scheduled time of passenger ride start. Do you start smell control?” and selection buttons “Yes” and “No”, and may activate the smell control function when “Yes” is selected. By presenting the proposal beforehand to the driver, the control unit 113 can start smell control at a more appropriate timing.

In S105, the control unit 113 determines whether to cause the deodorization device 15 or the air freshening device 16 to stop operation. When a smell control end instruction is received, or when a predetermined period of time has passed, the control unit 113 causes the deodorization device 15 or the air freshening device 16 to stop operation. The operator of the smell control device 11 may instruct at any timing via the input unit 111 that the smell control be ended. The control unit 113 may repeat an instruction to start and an instruction to stop operation of the deodorization device 15 or the air freshening device 16 at predetermined timings. After the control unit 113 causes the deodorization device 15 or the air freshening device 16 to stop operation, the operator of the smell control device 11 may instruct at any timing via the input unit 111 that the smell control be resumed.

As described above, in the first smell control method, the smell control device 11 starts smell control when a scheduled date and time of passenger ride start approaches. Accordingly, the smell control device 11 can deodorize, or add a fragrance to, the inside of the vehicle in advance before an occupant rides the vehicle 10, and thus can eliminate an unpleasant odor and make the inside of the vehicle smell comfortable.

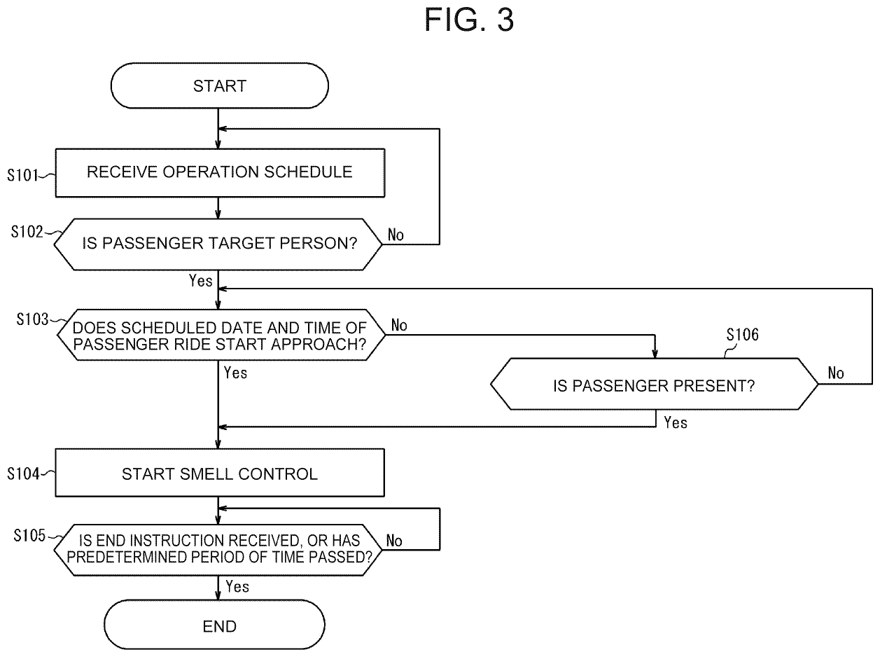

FIG. 3 is a flowchart showing a procedure of a second smell control method that is executed by the smell control device 11. Since S101 to S105 are the same as in the first smell control method, a description thereof is omitted.

In S106, before the scheduled date and time of passenger ride start approaches (No

In S103), the control unit 113 starts determination of the presence or absence of the passenger (whether the occupant has ridden the vehicle). The control unit 113 advances the processing to S104 when it is determined that the passenger is present, and returns the processing to S103 when it is determined that the passenger is absent.

The control unit 113 may determine the presence or absence of the passenger by receiving, from the microphone 12, an input of voice information picked up by the microphone 12, and analyzing the voice information. For example, the control unit 113 determines the presence or absence of the passenger by obtaining a voiceprint from the voice information picked up by the microphone 12, and comparing the voiceprint with a pre-registered voiceprint of the driver. Note that respective voiceprints of a plurality of occupants who uses the vehicle 10 may be stored beforehand in the storage unit 112, whereby the control unit 113 may identify the passenger.

The control unit 113 may determine the presence or absence of the passenger by receiving, from the camera 13, an input of image information picked up by the camera 13, and analyzing the image information. For example, the control unit 113 determines the presence or absence of the passenger by extracting a face image of a human from the image information picked up by the camera 13, and comparing the face image with a pre-registered face image of the driver. The control unit 113 may detect and authenticate the face image by using an existing technology, such as YOLO or convolutional neural network (CNN). Note that respective face images of a plurality of occupants who uses the vehicle 10 may be stored beforehand in the storage unit 112, whereby the control unit 113 may identify the passenger.

The control unit 113 may determine the presence or absence of the passenger by receiving, from the sensors 14, sensor information detected by the sensors 14, and analyzing the sensor information. For example, the control unit 113 may determine that the passenger is present when information indicating that a seatbelt is fastened in a seat other than the driver seat is acquired from a seatbelt sensor. The control unit 113 may determine that the passenger is present when information indicating that a load in a seat other than the driver seat increases by a threshold value or more is acquired from a weight sensor. The control unit 113 may determine the presence or absence of the passenger comprehensively by combining the determinations using the microphone 12, the camera 13, and the sensors 14.

As described above, in the second smell control method, the smell control device 11 starts smell control also when the occupant has ridden the vehicle 10 before the scheduled date and time of passenger ride start approaches, in addition to when the scheduled date and time of passenger ride start approaches. Accordingly, the smell control device 11 can perform smell control even if the occupant rides the vehicle at earlier time than originally scheduled. Moreover, the smell control device 11 can deodorize or add a fragrance when the passenger is already present before the scheduled date and time of passenger ride start approaches, and emanation of an unpleasant smell can be prevented while the passenger is on board.

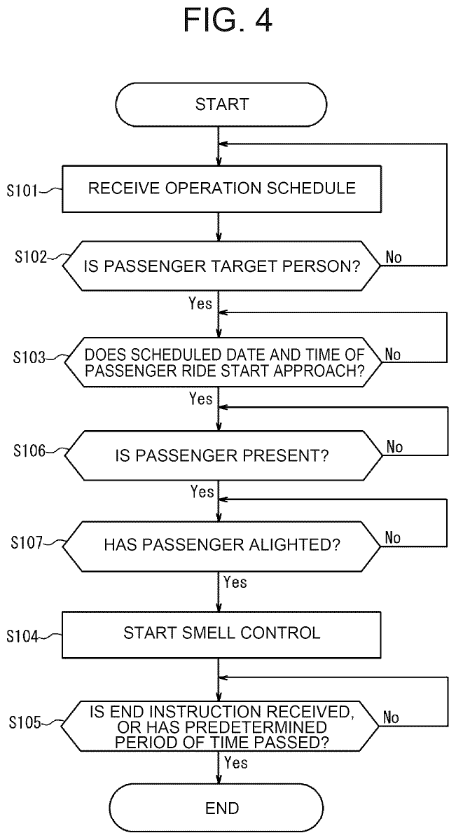

FIG. 4 is a flowchart showing a procedure of a third smell control method that is executed by the smell control device 11. Since S101 to S105 are the same as in the first smell control method, a description thereof is omitted.

In S106, when the scheduled date and time of passenger ride start approaches (Yes in S103), the control unit 113 starts determination of the presence or absence of the passenger. When the control unit 113 determines that the passenger is present, the control unit 113 advances the processing to S107. A method of determining the presence or absence of the passenger is the same as in the second smell control method.

In S107, the control unit 113 determines whether the passenger has alighted from the vehicle 10. When the control unit 113 determines that the passenger has alighted, the control unit 113 advances the processing to S104. The control unit 113 may determine whether the passenger has alighted by analyzing information detected by the sensors 14. For example, the control unit 113 determines that the passenger has alighted when, after information indicating that a seatbelt is unfastened in a seat other than the driver seat is acquired from a seatbelt sensor, information indicating that a door is unlocked is acquired from a key sensor, and information indicating that the door is opened and closed is acquired from a door sensor. The control unit 113 may determine whether the passenger has alighted by, as in S106, analyzing voice information picked up by the microphone 12, or analyzing image information picked up by the camera 13.

As described above, in the third smell control method, the smell control device 11 starts smell control when the passenger has alighted. Accordingly, the smell control device 11 can perform smell control after the passenger alights from the vehicle, without being noticed by the passenger. Thus, the smell control device 11 can arrange an in-vehicle environment to be ready for a time of a next passenger ride. The smell control device 11 may combine the first to third smell control methods. In other words, the smell control device 11 can deodorize, or add a fragrance to, the inside of the vehicle 10 at any of the timings when a scheduled date and time of passenger ride start approaches, when a passenger is already present before the scheduled date and time of passenger ride start approaches, and when the passenger has alighted. As described above, according to the smell control device 11 in the present embodiment, it is possible to control smell inside the vehicle at an appropriate timing.

### Program

It is also possible to use a program-instruction-executable computer to cause the computer to function as the smell control device 11. A program can cause the computer to function as the smell control device 11 by causing the computer to execute the operations described above.

The program can be stored in a non-transitory computer-readable medium. The non-transitory computer-readable medium is, for example, a flash memory, a magnetic recording device, an optical disc, a magneto-optical recording medium, or a ROM. Distribution of the program is performed, for example, by selling, transferring, or leasing a removable medium, such as a secure digital (SD) card, a digital versatile disc (DVD), or a compact disc read only memory (CD-ROM), that stores the program. The program may be distributed by storing the program in a storage of a server and transferring the program to another computer from the server. The program may be provided as a program product.

The computer temporarily stores in the storage unit 112, for example, the program stored in a removable medium or the program transferred from a server. Then, in the computer, the processor (control unit 113) reads the program stored in the storage unit 112, and the processor executes processes according to the read program. The computer may directly read the program from the removable medium and execute the processes according to the program. Each time the program is transferred from the server to the computer, the computer may successively execute the processes according to the received program. The processes may be executed by a so-called application service provider (ASP) service, which implements a function based on an instruction for execution and acquisition of a result, without the program being transferred from the server to the computer. The program includes information that is provided for processing by an electronic computer and that is equivalent to a program. For example, data that is not a direct command for a computer but has a property that defines processes by the computer corresponds to the “information equivalent to a program”.

Although the embodiment has been described as a representative example, various modifications or changes can be made without departing from the gist of the present disclosure. For example, as to the constituent blocks or the process steps described in the embodiment, multiple ones can be combined into a single one, or a single one can be divided into multiple ones.

For example, in S103, the processing is advanced when it is a predetermined period of time before the scheduled date and time of passenger ride start, and the deodorization device 15 or the air freshening device 16 is activated. However, the control unit 113 may adjust the predetermined period of time, based on environmental information. The environmental information may include at least any one of in-vehicle temperature, atmospheric pressure, weather, humidity, breathability, volatile organic compounds (VOC) concentration, smell intensity, carbon dioxide concentration, and air quality index (AQI). The rate of smell diffusion can change with the environmental information. For example, when the in-vehicle temperature is high, volatilization of a smell compound is promoted, and the rate of diffusion increases. When the humidity is high, the rate of diffusion may decrease because moisture adsorbs molecules of a smell. Moreover, it is conceivable that while a smell spreads quickly with good breathability, diffusion slows in an airtight state. As described above, the environmental information greatly affects the period of time for and the range of diffusion of a smell. For a method of acquiring environmental information, any scheme can be adopted. For example, the control unit 113 may acquire environmental information by acquiring a sensor value from a sensor that acquires the environmental information. Alternatively, the control unit 113 may acquire environmental information from an external device. The predetermined period of time is adjusted based on the environmental information, whereby a timing of smell control can be more appropriately set, and an in-vehicle environment that is comfortable for a user can be efficiently provided. Moreover, with such an adjustment, it can be expected that the effect of the smell control device 11 is maximized while wasteful energy consumption is reduced.

For example, in S105, the control unit 113 causes the deodorization device 15 or the air freshening device 16 to stop operation when a smell control end instruction is received, or when a predetermined period of time has passed. Here, the predetermined period of time may be adjusted based on environmental information. The environmental information may include at least any one of in-vehicle temperature, atmospheric pressure, weather, humidity, breathability, VOC concentration, smell intensity, carbon dioxide concentration, and air quality index (AQI). For a method of acquiring environmental information, any scheme can be adopted. For example, the control unit 113 may acquire environmental information by acquiring a sensor value from a sensor that acquires the environmental information. Alternatively, the control unit 113 may acquire environmental information from an external device. The predetermined period of time is adjusted based on the environmental information, whereby a timing of an end to smell control can be more appropriately set, and an in-vehicle environment that is comfortable for a user can be efficiently provided. Moreover, with such an adjustment, it can be expected that the effect of the smell control device 11 is maximized while wasteful energy consumption is reduced.

Note that when the environmental information is used for a process of adjusting the predetermined period of time in S103 or S105, for example, the control unit 113 may estimate a period of time for diffusion of a smell, based on the environmental information. Then, the control unit 113 may set the predetermined period of time, based on the estimated period of time for diffusion. A learning model may be used in such estimation. The learning model is a model created through machine learning using a machine learning algorithm. The learning model may be, for example, a machine learning model built based on a decision tree. Examples of the machine learning model built based on a decision tree include, but are not limited to, LightGBM, XGBoost, and the like. Alternatively, the learning model may be a model created based on a CNN, a recurrent neural network (RNN), or any other machine learning algorithm such as deep learning.

For example, the attribute information on a passenger is not limited to gender and age, which are recited as examples. The attribute information may include a health condition (an allergy to a specific odor eliminating component), a smell preference, a cultural background, a history of past selections, or the like. The control unit 113 may recognize attribute information on a passenger, and may instruct the deodorization device 15 or the air freshening device 16 to release a fragrance or an odor eliminating component that is varied based on the attribute information on the passenger. Thus, it is possible to provide an optimal in-vehicle environment according to the taste, the health condition, or the like of an individual passenger, and it can be expected that comfortability is enhanced, and that unpleasantness, a health risk, and the like are reduced. Moreover, since needs that vary from passenger to passenger can be responded, the degree of satisfaction with the vehicle as a whole can be increased, and a differentiated service can be realized. hereinafter, part of the embodiment of the present disclosure is illustrated. However, it should be noted that the embodiment of the present disclosure is not limited thereto.

### Supplementary Item 1

A smell control device including a control unit configured to:
acquire, from a server, operation schedule information indicating a schedule of operation of a vehicle;
from the operation schedule information, recognize an occupant who is to ride the vehicle, and determine whether the occupant is a target person of smell control; and
when the occupant is the target person, activate a smell control function before the occupant rides the vehicle, after the occupant rides the vehicle, or after the occupant alights from the vehicle.

### Supplementary Item 2

A smell control device including a control unit configured to recognize an occupant who is to ride a vehicle, and, when the occupant is a target person of smell control, activate a smell control function before the occupant rides the vehicle, after the occupant rides the vehicle, or after the occupant alights from the vehicle.

### Supplementary Item 3

The smell control device according to Supplementary Item 2, wherein the control unit is configured to, when the occupant is the target person, present, to a driver, a proposal that smell control be started before the occupant rides the vehicle, after the occupant rides the vehicle, or after the occupant alights from the vehicle, and activate the smell control function, based on an instruction from the driver.

### Supplementary Item 4

The smell control device according to Supplementary Item 2 or 3, wherein the control unit is configured to:
acquire information indicating a scheduled date and time at which the occupant rides the vehicle; and
activate the smell control function when a current date and time is a predetermined period of time before the scheduled date and time.

### Supplementary Item 5

The smell control device according to any one of Supplementary Items 2 to 4, wherein the control unit is configured to receive, from a microphone provided in the vehicle, an input of voice information picked up by the microphone, and determine riding or alighting of the occupant by analyzing the voice information.

### Supplementary Item 6

The smell control device according to any one of Supplementary Items 2 to 5, wherein the control unit is configured to receive, from a camera provided in the vehicle, an input of image information picked up by the camera, and determine riding or alighting of the occupant by analyzing the image information.

### Supplementary Item 7

The smell control device according to any one of Supplementary Items 2 to 6, wherein the control unit is configured to receive, from one or more sensors provided in the vehicle, sensor information detected by the one or more sensors, and determine riding or alighting of the occupant by analyzing the sensor information.

### Supplementary Item 8

The smell control device according to Supplementary Item 7, wherein the one or more sensors include a seatbelt sensor.

### Supplementary Item 9

The smell control device according to any one of Supplementary Items 2 to 8, wherein the smell control function is an odor elimination function, an odor removal function, or an air freshening function.

### Supplementary Item 10

A smell control method including:
by a smell control device,
acquiring, from a server, operation schedule information indicating a schedule of operation of a vehicle;
from the operation schedule information, recognizing an occupant who is to ride the vehicle, and determining whether the occupant is a target person of smell control; and
when the occupant is the target person, activating a smell control function before the occupant rides the vehicle, after the occupant rides the vehicle, or after the occupant alights from the vehicle.

### Supplementary Item 11

A smell control method including, by a smell control device, recognizing an occupant who is to ride a vehicle, and, when the occupant is a target person of smell control, activating a smell control function before the occupant rides the vehicle, after the occupant rides the vehicle, or after the occupant alights from the vehicle.

### Supplementary Item 12

The smell control method according to Supplementary Item 11, further including, by the smell control device, when the occupant is the target person, presenting, to a driver, a proposal that smell control be started before the occupant rides the vehicle, after the occupant rides the vehicle, or after the occupant alights from the vehicle, and activating the smell control function, based on an instruction from the driver.

### Supplementary Item 13

The smell control method according to Supplementary Item 11 or 12, further including:
by the smell control device,
acquiring information indicating a scheduled date and time at which the occupant rides the vehicle; and
activating the smell control function when a current date and time is a predetermined period of time before the scheduled date and time.

### Supplementary Item 14

The smell control method according to any one of Supplementary Items 11 to 13, further including:
by the smell control device,
receiving, from a microphone provided in the vehicle, an input of voice information picked up by the microphone; and
determining riding or alighting of the occupant by analyzing the voice information.

### Supplementary Item 15

The smell control method according to any one of Supplementary Items 11 to 14, further including:
by the smell control device,
receiving, from a camera provided in the vehicle, an input of image information picked up by the camera; and
determining riding or alighting of the occupant by analyzing the image information.

### Supplementary Item 16

The smell control method according to any one of Supplementary Items 11 to 15, further including:
by the smell control device,
receiving, from one or more sensors provided in the vehicle, sensor information detected by the one or more sensors; and
determining riding or alighting of the occupant by analyzing the sensor information.

### Supplementary Item 17

The smell control method according to Supplementary Item 16, wherein the one or more sensors include a seatbelt sensor.

### Supplementary Item 18

The smell control method according to any one of Supplementary Items 11 to 17,

wherein the smell control function is an odor elimination function, an odor removal function, or an air freshening function.

### Supplementary Item 19

A vehicle including:
the smell control device according to any one of Supplementary Items 1 to 9; and
a deodorization device,
   wherein when the occupant is the target person of smell control, the deodorization device eliminates or removes an odor, based on an instruction from the smell control device.

### Supplementary Item 20

A vehicle including:
the smell control device according to any one of Supplementary Items 1 to 9; and
an air freshening device,
   wherein when the occupant is the target person of smell control, the air freshening device releases a fragrance, based on an instruction from the smell control device.

What is claimed is:

1. A smell control device comprising a processor configured to:
acquire, from a server, operation schedule information indicating a schedule of operation of a vehicle;
based on the operation schedule information, recognize an occupant who is to get on the vehicle, and determine whether the occupant is a target person of smell control; and
in response to determining that the occupant is the target person, activate a smell control function before the occupant gets on the vehicle, after the occupant gets on the vehicle, or after the occupant gets off the vehicle.

2. A smell control device comprising a processor configured to recognize an occupant who is to get on a vehicle, and, in a case that the occupant is a target person of smell control, activate a smell control function before the occupant gets on the vehicle, after the occupant gets on the vehicle, or after the occupant gets off the vehicle.

3. The smell control device according to claim 2, wherein the processor is configured to:
in a case that the occupant is the target person, present, to a driver, a proposal that smell control be started before the occupant gets on the vehicle, after the occupant gets on the vehicle, or after the occupant gets off the vehicle; and
activate the smell control function based on an instruction from the driver.

4. The smell control device according to claim 2, wherein the processor is configured to:
acquire information indicating a scheduled date and time at which the occupant gets on the vehicle; and
activate the smell control function in response to a current date and time reaching a predetermined period of time prior to the scheduled date and time.

5. The smell control device according to claim 2, wherein the processor is configured to;
receive, from a microphone provided in the vehicle, an input of voice information picked up by the microphone;
analyze the voice information; and
determine whether the occupant gets on or gets off the vehicle based on an analysis result.

6. The smell control device according to claim 2, wherein the processor is configured to;
receive, from a camera provided in the vehicle, an input of image information picked up by the camera;
analyze the image information; and
determine whether the occupant gets on or gets off the vehicle based on an analysis result.

7. The smell control device according to claim 2, wherein the processor is configured to;
receive, from one or more sensors provided in the vehicle, sensor information detected by the one or more sensors;
analyze the sensor information; and
determine whether the occupant gets on or gets off the vehicle based on an analysis result.

8. The smell control device according to claim 7, wherein the one or more sensors include a seatbelt sensor.

9. The smell control device according to claim 2, wherein the smell control function is an odor elimination function, an odor removal function, or an air freshening function.

10. A smell control method comprising, by a smell control device, recognizing an occupant who is to get on a vehicle, and, in a case that the occupant is a target person of smell control, activating a smell control function before the occupant gets on the vehicle, after the occupant gets on the vehicle, or after the occupant gets off the vehicle.

11. The smell control method according to claim 10, further comprising:
by the smell control device,
in a case that the occupant is the target person, presenting, to a driver, a proposal that smell control be started before the occupant gets on the vehicle, after the occupant gets on the vehicle, or after the occupant gets off from the vehicle; and
activating the smell control function, based on an instruction from the driver.

12. The smell control method according to claim 10, further comprising:
by the smell control device,
acquiring information indicating a scheduled date and time at which the occupant gets on the vehicle; and
activating the smell control function in response to a current date and time reaching a predetermined period of time prior to the scheduled date and time.

13. The smell control method according to claim 10, further comprising:
by the smell control device,
receiving, from a microphone provided in the vehicle, an input of voice information picked up by the microphone;
analyzing the voice information; and
determining whether the occupant gets on or gets off the vehicle based on an analysis result.

14. The smell control method according to claim 10, further comprising:
by the smell control device,
receiving, from a camera provided in the vehicle, an input of image information picked up by the camera;
analyzing the image information; and
determining whether the occupant gets on or gets off the vehicle based on an analysis result.

15. The smell control method according to claim 10, further comprising:
by the smell control device,
receiving, from one or more sensors provided in the vehicle, sensor information detected by the one or more sensors;
analyzing the sensor information; and
determining whether the occupant gets on or gets off the vehicle based on an analysis result.

16. The smell control method according to claim 15, wherein the one or more sensors include a seatbelt sensor.

17. The smell control method according to claim 10, wherein the smell control function is an odor elimination function, an odor removal function, or an air freshening function.

18. A vehicle comprising:
the smell control device according to claim 1; and
a deodorization device,
wherein in response to determining that the occupant is the target person of smell control, the deodorization device is configured to eliminate or remove an odor, based on an instruction from the smell control device.

19. A vehicle comprising:
the smell control device according to claim 1; and
an air freshening device,
wherein in response to determining that the occupant is the target person of smell control, the air freshening device is configured to release a fragrance, based on an instruction from the smell control device.
